(19) United States
(12) Patent Application Publication
(10) Pub. No.: US 2021/0279582 A1
(43) Pub. Date: Sep. 9, 2021

(54) SECURE DATA PROCESSING

(71) Applicant: Via Science, Inc., Somerville, MA (US)

(72) Inventors: John Christopher Muddle, Montreal (CA); Mathew Rogers, Montreal (CA); Jesus Alejandro Cardenes Cabre, Montreal (CA); Jeremy Taylor, Montreal (CA); Colin Gounden, Cambridge, MA (US); Kai Chung Cheung, Markham (CA)

(21) Appl. No.: 17/329,447

(22) Filed: May 25, 2021

Related U.S. Application Data
(63) Continuation of application No. 17/072,628, filed on Oct. 16, 2020.
(60) Provisional application No. 62/916,512, filed on Oct. 17, 2019.
(60) Provisional application No. 62/916,825, filed on Oct. 18, 2019.
(60) Provisional application No. 62/939,045, filed on Nov. 22, 2019.

(51) Int. Cl. G06N 3/08; H04L 9/08; H04L 9/30

(52) U.S. Cl. CPC G06N 3/08; H04L 9/30; H04L 9/088

(57) ABSTRACT

Multiple systems may determine neural-network output data and neural-network parameter data and may transmit the data therebetween to train and run the neural-network model to predict an event given input data. A secure processing component may process data using a transformation layer and may send and receive data to and from a first system. Multiple data-provider systems may send vertically partitioned data to the secure-processing component, which may determine output data corresponding to the multiple data-provider systems.

### CROSS-REFERENCE TO RELATED APPLICATION DATA

This application is a continuation of, and claims the benefit of priority of, U.S. Non-Provisional patent application Ser. No. 17/072,628, filed Oct. 16, 2020 and entitled “SECURE DATA PROCESSING,” which claims the benefit of and priority to U.S. Provisional Patent Application No. 62/916,512, filed Oct. 17, 2019, and entitled “Learning Network Modules Over Vertically Partitioned Data Sets,” in the names of John Christopher Muddle, et al.; U.S. Provisional Patent Application No. 62/916,825, filed Oct. 18, 2019, and entitled “TAC Learning of Models to Protect AP's IP from DO,” in the names of Mathew Rogers, et al.; and U.S. Provisional Patent Application No. 62/939,045, filed Nov. 22, 2019, and entitled “TAC Learning of Models to Protect AP's IP from DO,” in the names of Mathew Rogers, et al. The contents of each of which are expressly incorporated herein by reference in their entirety.

### BACKGROUND

Data security and encryption is a branch of computer science that relates to protecting information from disclosure to third parties and allowing only an intended party or parties access to that information. The data may be encrypted using various techniques, such as public/private key cryptography and/or elliptic cryptography, and may be decrypted by the intended recipient using a corresponding decryption technique.

### BRIEF DESCRIPTION OF DRAWINGS

For a more complete understanding of the present disclosure, reference is now made to the following description taken in conjunction with the accompanying drawings.

FIGS. 1A and 1B illustrate systems configured to securely process data according to embodiments of the present disclosure.

FIG. 2 illustrates a computing environment including a model-provider system, a data-provider system, and a data/model processing system according to embodiments of the present disclosure.

FIGS. 3A and 3B illustrate model input data according to embodiments of the present disclosure.

FIGS. 4A and 4B illustrate layers of a neural-network model configured to securely process data according to embodiments of the present disclosure.

FIGS. 5A, 5B, 5C, 5D, and 5E illustrate processes for securely processing data according to embodiments of the present disclosure.

FIGS. 6A, 6B, and 6C illustrate processes for securely processing data according to embodiments of the present disclosure.

FIG. 7 is a conceptual diagram of components of a system according to embodiments of the present disclosure.

FIG. 8 is a conceptual diagram of a network according to embodiments of the present disclosure.

### SUMMARY

In various embodiments of the present disclosure, a first system is a data-provider system and communicates with a second system that is a data/model processing system and a third system that is a model-provider system. The first and third systems permit the second system to process data corresponding to input data to predict an event corresponding to the input data. The input data may include data corresponding to a component, such as voltage, current, temperature, and/or vibration data, data corresponding to movement of material and/or information in a network, such as the flow of energy and/or information, as well as other data. The event may include a change in performance of the component, including failure of the component, a change in the amount of movement, as well as other events.

### DETAILED DESCRIPTION

Machine-learning systems, such as those that use neural networks, may be trained using training data and then used to make predictions on out-of-sample (i.e., non-training) data to predict an event. A system providing this data, referred to herein as a data-provider system, may acquire this data from one or more data sources. The data-provider system may be, for example, a power company, and may collect data regarding operational status of a particular component (e.g., a transformer); this data may include, for example, temperature, vibration, and/or voltage data collected during use of the component. The data may further include rates of movement of material and/or information in a network and/or other factors that may affect the operation and/or movement, such as atmospheric and/or weather conditions and/or inputs to the component and/or network. The data-provider system may then annotate this data to indicate times at which the component failed. Using this collected and annotated data, the data-provider system may train a neural network to predict an event associated with the input data, such as when the same or similar component will next fail based on the already-known times of past failure and/or changes in the movement of the network. Once trained, the data-provider system may deploy the model to attempt to receive additional data collected from the component and make further predictions using this out-of-sample data.

The data-provider system may, however, have access to insufficient training data, training resources, or other resources required to train a model that is able to predict a given event (e.g., failure of the component and/or change in the network) with sufficient accuracy. The data-provider system may thus communicate with another system, such as a model-provider system, that includes such a model. The data-provider system may thus send data regarding the data source(s) to the model-provider system, and the model-provider system may evaluate the model using the data to predict the event. The model of the model-provider system may be trained using data provided by the data-provider system, other data-provider system(s), and/or other sources of data.

The data-provider system may, however, wish to keep the data from the one or more data sources private and may further not wish to share said data with the model-provider system. The model-provider system may similarly wish to keep the model (and/or one or more trained parameters and/or results thereof) secret with respect to the data-provider system (and/or other systems). A third system, such as a secure processor, may thus be used to process data using one or more layers of the model (such as one or more transformation layers, as described herein) to thus prevent the data-provider system from being able to learn input data, output data, and/or parameter data associated with the full model.

For example, the power company may improve their model by training it with additional training data, but this additional training data may not be accessible to the power company. A rival power company, for example, may possess some additional training data, but may be reluctant to provide their proprietary intellectual property to a competitor. In other industries or situations, data owners may further be predisposed to not share their data because the data set is too large to manage or because it is in a different format from other data. In still other industries, data owners may be prohibited to share data, such as medical data, due to state laws and/or regulations. A data owner may further be predisposed to not share data, especially publicly, because any further monetary value in further sharing of the data is lost after sharing the data once. The transformation layer(s), described herein, may permit a given data-provider system access to the benefit of using such a trained model (e.g., predicted events based on shared training data) but not permit the given data-provider system from knowing all of the parameters of the trained model.

In other embodiments, a single data-provider system may not possess or be able to obtain all the data necessary to provide input to a model to make an accurate prediction of the event(s). The type of data possessed by the data-provider system may thus be referred to as vertically partitioned data (as opposed to horizontally partitioned data, which is data that is able to provide all of the inputs to the model). A first data-provider system may possess a first portion of the input data for the model, and a second data-provider system may possess a second portion of the input data. Each data-provider system may wish to make a prediction using the model but may not wish to share its portion of the input data with other data-provider system(s).

Embodiments of the present disclosure thus relate to systems and methods for securely processing data, such as the training data described above, collected from one or more data-provider systems. In some embodiments, some layer(s) of the model are disposed on a first system and other layer(s) of the model are disposed on a second system. If, for example, a model-provider system provides a model to a data-provider system, the model-provider system may prevent the data-provider system from having full access to the model, and in particular all of the parameters associated with the model, by using a third system, referred to herein as a secure processor, to process data using at least one layer of the model.

In other embodiments, a first data-provider may process a first portion of vertically partitioned data using first input layer(s), and a second data-provider system may process a second portion of the vertically partitioned data using second input layer(s). Each data-processing system may send the results of this processing, referred to herein as feature data, to a secure processor, which may combine the feature data and send result(s) of processing the feature data back to the data-provider systems. Thus each data-provider system may receive the benefit of training the model using data from at least one other data-provider system without having access to the actual data of the other data-provider system(s)

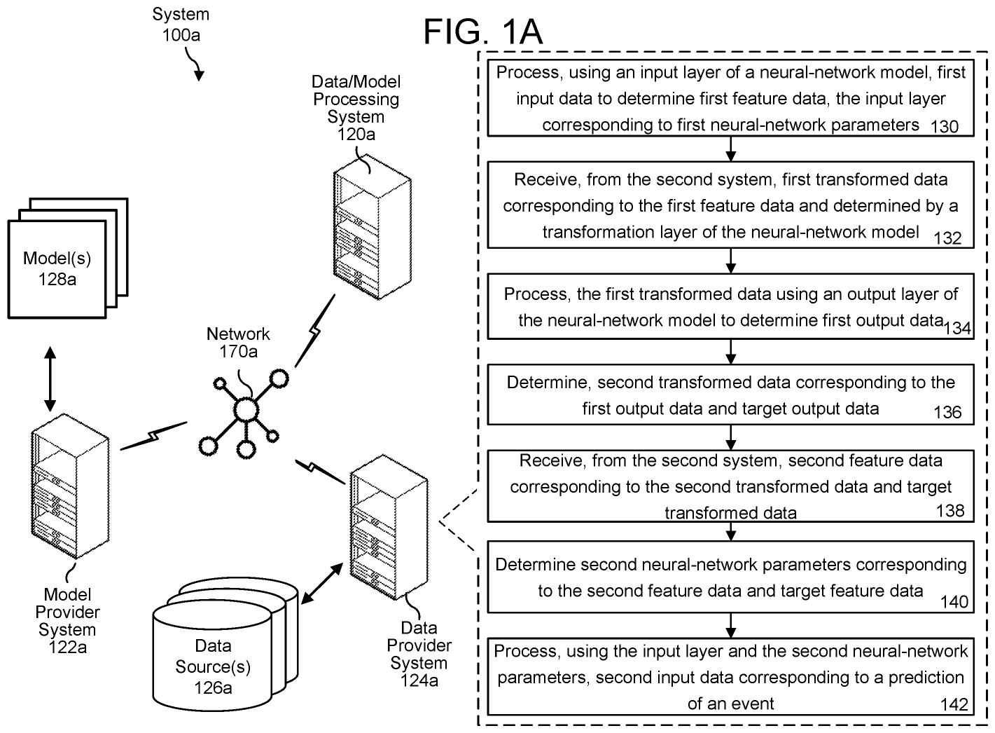

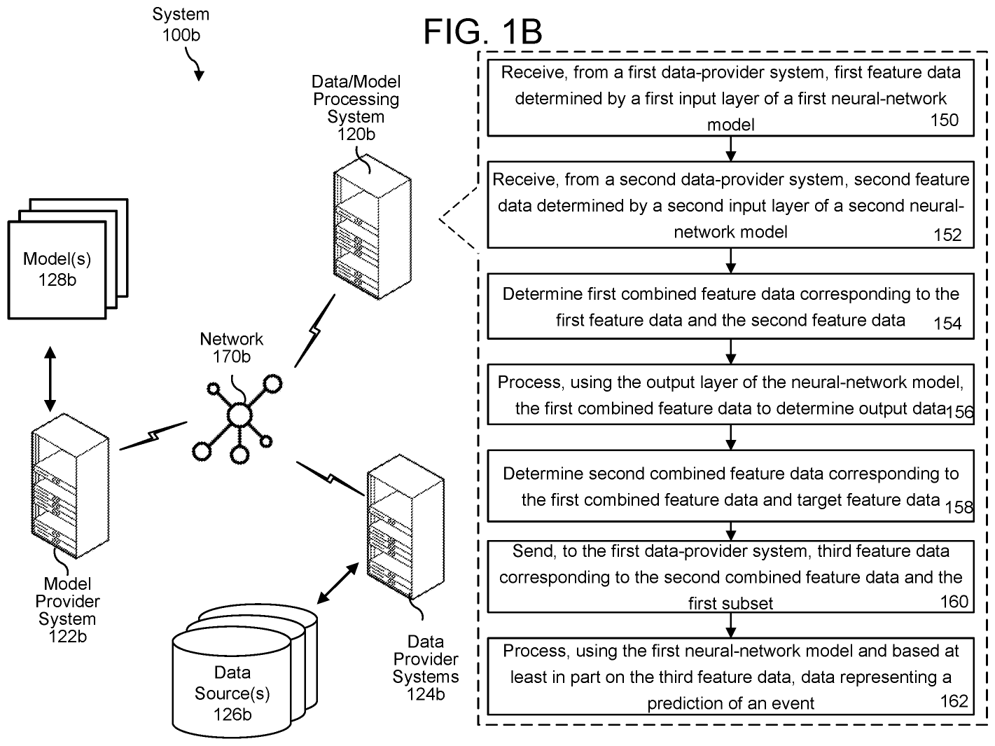

FIGS. 1A and 1B show systems that include a data/model processing system 120, a model-provider system 122, a data-provider system 124, and a network 170. The network 170 may include the Internet and/or any other wide- or local-area network, and may include wired, wireless, and/or cellular network hardware. The data/model processing system 120 may communicate, via the network 170, with one or more model-provider systems 122 and/or data-provider systems 124. The data/model processing system 120 may transmit, via the network 170, requests to the other systems using one or more application programming interfaces (APIs). Each API may correspond to a particular application. A particular application may, for example, be operated within the data/model processing system 120 or may be operated using one or more of the other systems.

Referring first to FIG. 1A, in accordance with the present disclosure, a system 100a includes a data/model processing system 120a, a model-provider system 122a, one or more model(s) 128a, a data-provider system 124a, and one or more data source(s) 126a. A first system (e.g., the data-provider system) processes (130), using an input layer of a neural-network model, first input data to determine first feature data, the input layer corresponding to first neural-network parameters. The first system sends, to a second system, (e.g., the data/model processing system), the first feature data, and receives (132), from the second system, first transformed data corresponding to the first feature data and determined by a transformation layer of the neural-network model. The first system processes (134) the first transformed data using an output layer of the neural-network model to determine first output data. The first system determines (136) second transformed data corresponding to the first output data and target output data. The first system sends, to the second system, the second transformed data, and receives (138), from the second system, second feature data corresponding to the second transformed data and target transformed data. The first system determines (140) second neural-network parameters corresponding to the second feature data and target feature data. The first system processes (142), using the input layer and the second neural-network parameters, second input data corresponding to an event to determine third feature data representing a prediction of the event.

Referring to FIG. 1B, in accordance with the present disclosure, a system 100b includes a data/model processing system 120b, a model-provider system 122b, one or more model(s) 128b, 13240282.15 two or more data-provider system(s) 124b, and one or more data source(s) 126b. A second system (e.g., the data/model processing system 120b) receives (150), from a first data-provider system, first feature data determined by a first input layer of a first neural-network model, the first feature data corresponding to a first subset of inputs to an output layer of the neural-network model. The second system receives (152), from a second data-provider system, second feature data determined by a second input layer of a second neural-network model, the second feature data corresponding to a second subset of inputs to the output layer of the neural-network model. The second system determines (154) first combined feature data corresponding to the first feature data and the second feature data. The second system processes (156), using the output layer of the neural-network model, the first combined feature data to determine output data. The second system determines (158) second combined feature data corresponding to the first combined feature data and target feature data. The second system sends (160), to the first data-provider system, third feature data corresponding to the second combined feature data and the first subset. The second system and/or first data-provider system processes (162), using the first neural-network model and based at least in part on the third feature data, input data corresponding to an event to determine fourth feature data representing a prediction of the event.

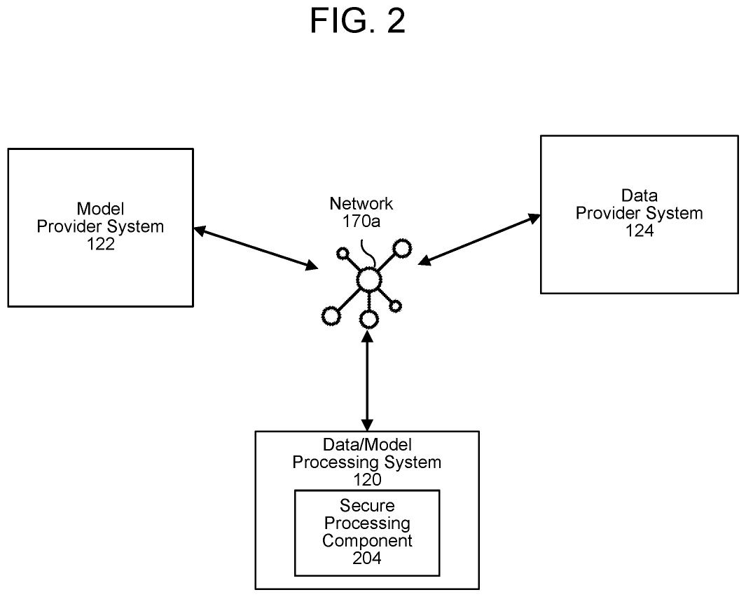

FIG. 2 illustrates a computing environment including a model-provider system 122, a data/model processing system 120, and a data-provider system 124 according to embodiments of the present disclosure. The model-provider system 122, data/model processing system 120, data-provider system 124 may be one or more servers 700 configured to send and/or receive encrypted and/or other data from one or more of the model-provider system 122, data/model processing system 120, and/or data-provider system 124. The model-provider system 122 may include and/or train a model, such as a neural-network machine-learning model, configured to process data from the one or more data-provider system(s) 124.

The data/model-processing system 120a may include a number of other components. In some embodiments, the data/model-processing system 120 includes one or more secure-processing component(s) 204. Each secure-processing component 204 may store or otherwise access data that is not available for storage and/or access by the other systems 122, 124 and/or other components 204. For example, the data encryption/decryption component may store and/or access the private key κ⁻, other components, such as a homomorphic operation component and/or a data-evaluation component may not store and/or have access to the private key κ⁻. The components may be referred to as containers, data silos, and/or sandboxes.

As described herein, one or more of the model-provider system 122, a data/model processing system 120, and a data-provider system may exchange data, such as model-output data, layer-output data, and/or parameter data. In some embodiments, some or all of this data may be encrypted prior to sending and/or decrypted upon receipt in accordance with one or more encryption functions, described below. For example, a first data-provider system 124a may exchange encryption information with a second data-provider system 124b and/or a model-provider system 122, as defined below, before exchanging data (such as, for example, neural-network parameters) encrypted using the encrypted information. In other embodiments, however, data exchanged between the data/model processing system 120, model-provider system 122, and/or data-provider system 124 is not encrypted. In some embodiments, one or more homomorphic operations are performed by the data/model processing system 120; in other words, the data/model processing system may act as an aggregator of data sent between the data-provider system(s) 124 and/or the model-provider system 122. Sending encrypted or unencrypted data is within the scope of the present disclosure.

For example, if encryption is used to exchange data, an RSA encryption function H(m) may be defined as shown below in equation (1), in which a and n are values configured for a specific encryption function.

H(m)=a^{me}(mod n) (1)

A corresponding decryption function H⁻¹(c) may be used to decrypt data encrypted in accordance with the encryption function of equation (1). In some embodiments, the decryption function H⁻¹ (c) is defined using the below equation (2), in which logₐ is the discrete logarithm function over base a. The algorithm function log, may be computed by using, for example, a “baby-step giant-step” algorithm.

H⁻¹=logₐ(c^{d})(mod n) (2)

In various embodiments, data encrypted using the encryption function H(m) is additively homomorphic such that H(m₁+m₂) may be determined in accordance with the below equations (3) and (4).

H(m₁+m₂)=a^{(m}^{₁}^{+m}^{₂}^{)e}(mod n) (3)

H(m₁+m₂)=a^{m}^{₁}^{+m}^{₂}^{e}(mod n) (4)

In some embodiments, the above equations (3) and (4) may be computed or approximated by multiplying H(m1) and H(m2) in accordance with the below equation (5) and in accordance with the homomorphic encryption techniques described herein.

H(m₁+m₂)=H(m₁)H(m₂) (5)

Similarly, the difference between H(m1) and H(m2) may be determined by transforming H(m1) and H(m2) into its negative value in accordance with equation (6).

H(m₁−m₂)=H(m₁)×(−1)H(m₂) (6)

The result of Equation (6) may be the encrypted difference data described above.

Homomorphic encryption using elliptic-curve cryptography utilizes an elliptic curve to encrypt data, as opposed to multiplying two prime numbers to create a modulus, as described above. An elliptic curve E is a plane curve over a finite field Fₚ of prime numbers that satisfies the below equation (7).

y²=x³+ax+b (7)

The finite field Fₚ of prime numbers may be, for example, the NIST P-521 field defined by the U.S. National Institute of Standards and Technology (NISI). In some embodiments, elliptic curves over binary fields, such as NIST curve B-571, may be used as the finite field Fₚ of prime numbers. A key is represented as (x,y) coordinates of a point on the curve; an operator may be defined such that using the operator on two (x,y) coordinates on the curve yields a third (x,y) coordinate also on the curve. Thus, key transfer may be performed by transmitting only one coordinate and identifying information of the second coordinate.

The above elliptic curve may have a generator point, G, that is a point on the curve—e.g., G=(x,y)∈E. A number n of points on the curve may have the same order as G—e.g., n=o(G). The identity element of the curve E may be infinity. A cofactor h of the curve E may be defined by the following equation (8).

$$h = \frac{\vert E ( {F}_{p} ) \vert}{o ( G )} \qquad ( 8 )$$

A first party, such as the data/model processing system 120, model provider system 122, and/or model provider system 122, may select a private key n_{B} that is less than o(G). In various embodiments, at least one other of the data/model processing system 120, model provider system 122, and/or model provider system 122 is not the first party and thus does not know the private key n_{B}. The first party may generate a public key P_{B} in accordance with equation (9).

P_{B}=n_{B}G=∈ᵢⁿ^{_{B}}G (9)

The first party may then transmit the public key P_{B} to a second party, such as one or more of the data/model processing system 120, model provider system 122, and/or model provider system 122. The first party may similarly transmit encryption key data corresponding to domain parameters (p, a, b, G, n, h). The second party may then encrypt data m using the public key P_{B}. The second party may first encode the data m; if m is greater than zero, the second party may encode it in accordance with mG; m is less than zero, the second party may encode it in accordance with (−m)G⁻¹. If G=(x,y), G⁻¹=(x,−y). In the below equations, however, the encoded data is represented as mG for clarity. The second party may perform the encoding using, for example, a doubling-and-adding method, in O(log(m)) time.

To encrypt the encoded data mG, the second party may select a random number c, wherein c is greater than zero and less than a finite field prime number p. The second party may thereafter determine and send encrypted data in accordance with the below equation (10).

H(m)={cG,mG+P_{B}} (10)

A corresponding decryption function H⁻¹(m) may be used to decrypt data encrypted in accordance with the encryption function of equation (1). The decrypted value of H(m) is m, regardless of the choice of large random number c. The first party may receive the encrypted data from the second party and may first determine a product of the random number c and the public key P_{B} in accordance with equation (11).

cP_{B}=c(n_{B}G)=n_{B}(cG) (11)

The first party may then determine a product of the data m and the generator point Gin accordance with the below equation (12).

mG=(mG+cP_{B})−n_{B}(cG) (12)

Finally, the first party may decode mG to determine the data m. This decoding, which may be referred to as solving the elliptic curve discrete logarithm, may be performed using, for example, a baby-step-giant-step algorithm in O(\sqrt{m}) time.

In various embodiments, data encrypted using the encryption function H(m) is additively homomorphic. That is, the value of H(m₁+m₂) may be expressed as shown below in equation (13).

H(m₁+m₂)={cG,(m₁+m₂)G+CP_{B}} (13)

The value of H(m₁)+H(m₂) may be expressed as shown below in equations (14) and (15).

$$\begin{matrix}H ( {m}_{1} ) + H ( {m}_{2} ) = \{ {c}_{1} G , {m}_{1} G + {c}_{1} {P}_{B} \} + \{ {c}_{2} G , {m}_{2} G + {c}_{2} {P}_{B} \} & ( 14 ) \\ H ( {m}_{1} ) + H ( {m}_{2} ) = \{ ( {c}_{1} + {c}_{2} ) G , ( {m}_{1} + {m}_{2} ) G + ( {c}_{1} + {c}_{2} ) {P}_{B} \} & ( 15 )\end{matrix}$$

Therefore, H(m₁+m₂)=H(m₁)+H(m₂). Similarly, if m is negative, H(m) may be expressed in accordance with equation (16).

H(m)={cG,(−m)G⁻¹+CP_{B}} (16)

H(m₁)−H(m₂) may thus be expressed as below in accordance with equation (17).

$$\begin{matrix}H ( {m}_{1} ) - H ( {m}_{2} ) = H ( {m}_{1} ) + H ( - {m}_{2} ) \\ = \{ ( {c}_{1} + {c}_{2} ) G , ( {m}_{1} - {m}_{2} ) G + ( {c}_{1} + {c}_{2} ) {P}_{B} \} \\ = H ( {m}_{1} - {m}_{2} )\end{matrix} \qquad ( 17 )$$

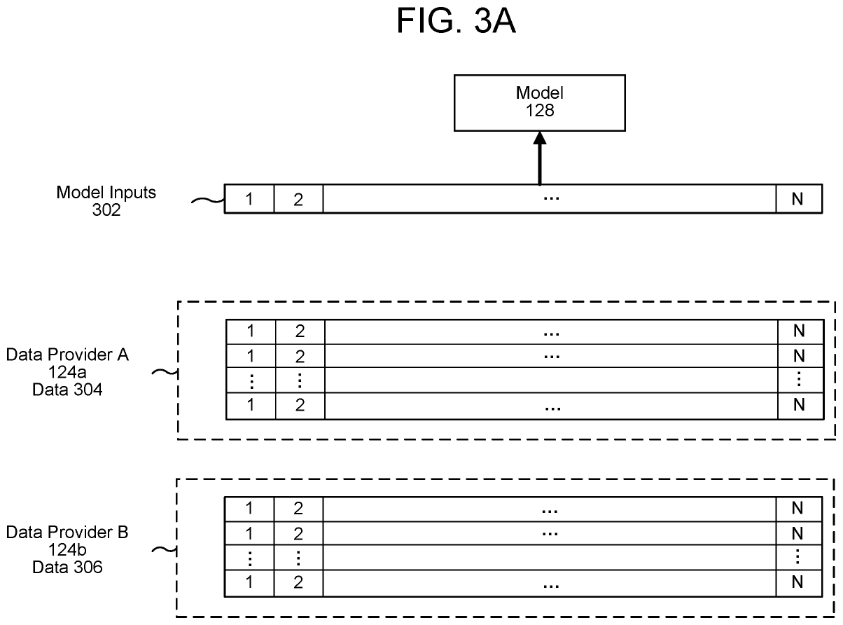

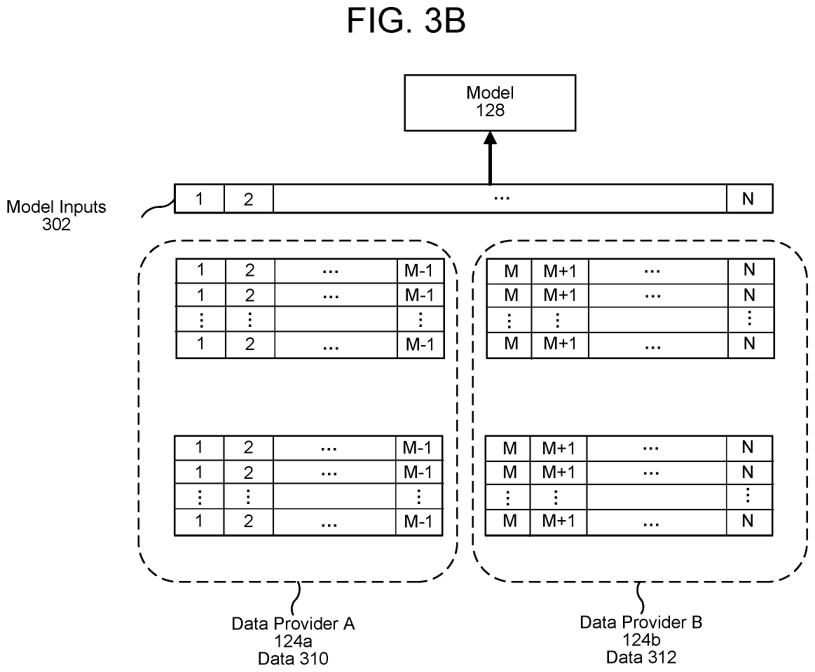

FIGS. 3A and 3B illustrate model input data according to embodiments of the present disclosure. In each figure, the model 128 receives, as input, model inputs 302, which may be a vector of 1-N numbers. One or more layers of the model 128 may then processing the model inputs 302, as described herein, to determine output data of the model 128. As also described herein, the layers of the model 128 may be distributed across one or more systems. FIG. 3A illustrates horizontally partition data 304, 306, and FIG. 3B illustrates vertically partitioned data 310, 312. Each of these figures is described in greater detail below.

Referring first to FIG. 3A, a first data provider A 124a determines first data 304, and a second data provider B 124b determines second data 306. Any number of data providers 124 may, however, determine any number of data, and the present disclosure is not limited to only two data providers 124.

Each data 304, 306 of each data provider 124a, 124b may include a number of vectors of data having dimension N, which may be the same dimension of the model input data 302. That is, each data provider 124a, 124b determines data that represents each of the inputs of the model 128. Thus, a single data provider 124 may provide all the inputs necessary to the model 128 in order for the model to begin processing data. This arrangement of data may thus be referred to as horizontally partitioned data. Each data provider 124 may determine any number of vectors of dimension N for processing by the model 128.

Referring to FIG. 3B, a first data provider A 124a determines first data 310, and a second data provider B 124b determines second data 312. The first data 310 represents a first subset of the model inputs 302, and the second data 312 represents a second subset of the model inputs 302. The first subset and the second subset together may represent all of the model inputs 302. For example, the first data 310 may represent values 1-M−1 of the model inputs, and the second data 312 may represent values M−N of the model inputs 302. Thus, at least a portion of the first data 310 and at least a portion of the second data 312 may be required to provide the input data 302 used by the model 128 to determine output data. This arrangement of data may be referred to as vertically partitioned data.

FIG. 3B illustrates two data providers 124a, 124b that provide the model input data 302. In other embodiments, any number of data providers 124 may provide the model input data 302; that is, the model input data 302 may be vertically partitioned among any number of data providers 124. FIG. 3B further illustrates that the first data provider A 124a provides a first subset of the model input data 302, and the second data provider 124b provides a second, non-overlapping second subset of the model input data 302. In other embodiments, one or more data providers 124 may determine data that wholly or partially overlaps with data from one or more other data providers 124. That is, a first data provider 124a may determine data at least a portion of which is similarly determined by a second data provider 124b. In other embodiments, first and second data providers 124a, 124b may determine vertically partitioned data, as illustrated in FIG. 3B, while a third data provider may determine horizontally partitioned data; that is, the third data provider may determine data that corresponds to all of the values of the model input data 302. Any number of data providers 124, and any arrangement of horizontal partitioning and/or overlapping and/or non-overlapping vertical partitioning is, however, within the scope of the present disclosure.

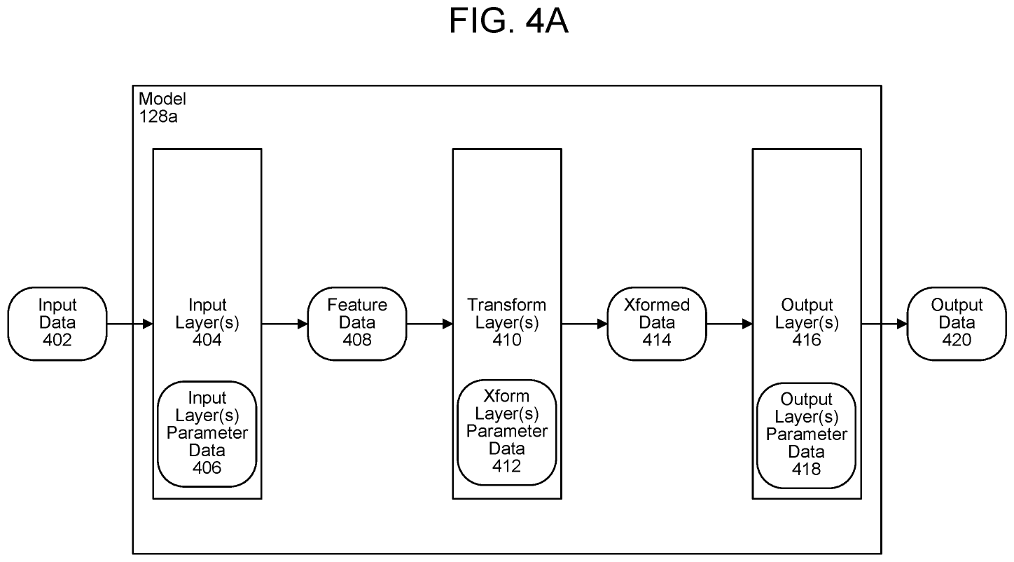

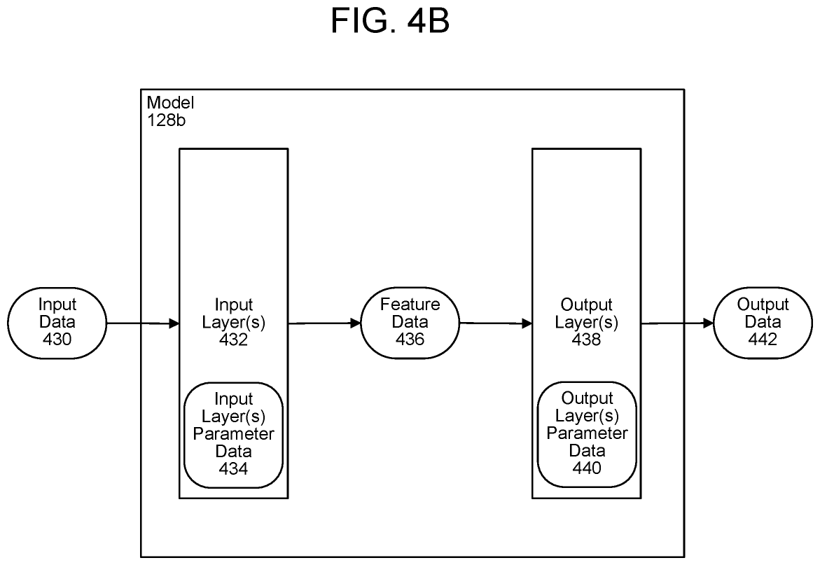

FIGS. 4A and 4B illustrate layers of a neural-network model configured to securely process data according to embodiments of the present disclosure. The layers may be distributed across different systems, such as the data provider system 124, the secure processor 204, and/or other systems. Each layer may be comprised of nodes having corresponding parameter data, such as weight data, offset data, or other data. Each layer may process input data in accordance with the parameter data to determine output data. The output data may, in turn, be processed by another layer disposed on the same system as that of the first layer or on a different system.

Referring first to FIG. 4A, a model 128a may include one or more input layer(s) 404, one or more transform layer(s) 410, and one or more output layer(s) 416. The input layer(s) 404 and output layer(s) 416 may include a number of neural-network nodes arranged in each layer to form a deep neural network (DNN) layer, such as a convolutional neural network (CNN) layer, a recurrent neural network (RNN) layer, such as a long short-term memory (LSTM) layer, or other type of layer. The transform layer(s) 410 may include a number of network nodes arranged in each layer to form a transformation function, such as an affine transform function, activation function, and/or other type of linear and/or nonlinear transformation function.

One or more input layer(s) 404 may process input data 404 in accordance with input layer(s) parameter data 406 to determine feature data 408. In some embodiments, the input layer(s) 404 are disposed on a data-provider system 124. The input data 402 may comprise one or more vectors of N values corresponding to data collected from one or more data sources 126. The feature data 408 may be processed by the transform layer(s) 410 in accordance with transform layer(s) parameter data 412 to determine transform data 414. The transformed data 414 may be processed using output layer(s) 416 in accordance with output layer(s) parameter data 418 to determine output data 420. As described herein, the input layer(s) 404 and output layer(s) 416 may be disposed on a data-provider system 124, and the transform layer(s) 410 may be disposed on a secure-processing component 204.

With reference to FIG. 4B, one or more input layer(s) 432 may process input data 430 in accordance with input layer(s) parameter data 434 to determine feature data 436. As described herein, the input data 430 may be vertically partitioned data, such as the data 310, 312 illustrated in FIG. 3B, and may be disposed on two or more data-provider systems 124. Each data-provider system 124 may include input layer(s) 404 for processing the vertically partitioned data determined by that data-provider system 124; the secure-processing component 204 may include further input layer(s) 404 for processing feature data 408 determined by multiple data-provider systems 124 and for determining input layer(s) parameter data derived therefrom.

Similarly, output layer(s) 438 may process the feature data 436 to determine output data 442. Each data-provider system 124 may include output layer(s) 438 configured to process feature data 436 in accordance with output layer(s) parameter data 440 corresponding to that data-provider system 124; the secure-processing component 204 may include further output layer(s) 438 for processing feature data 436 in accordance with output layer(s) parameter data 440 corresponding to multiple data-provider systems 124.

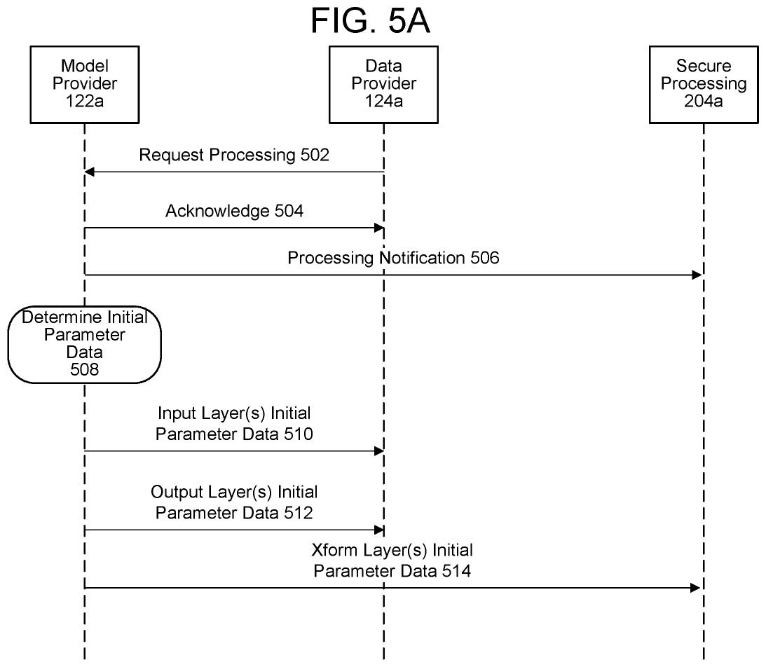

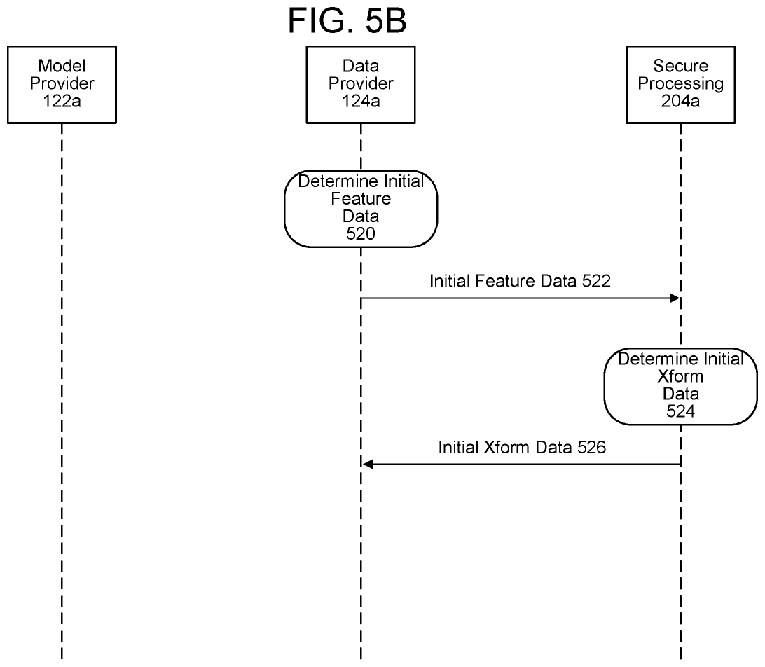

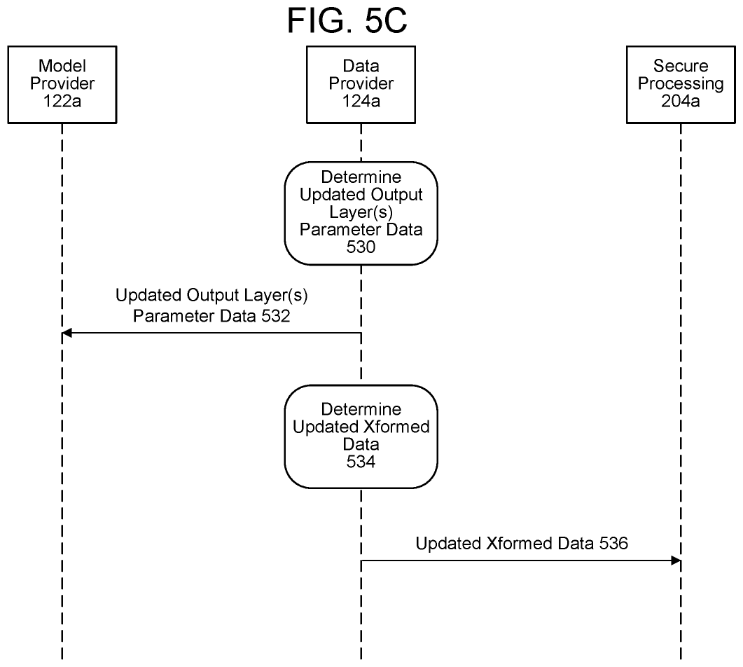

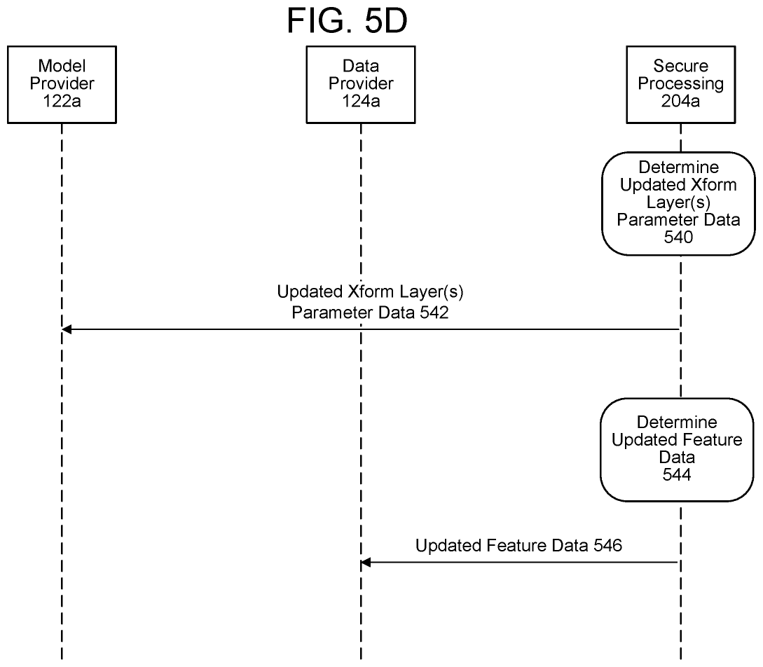

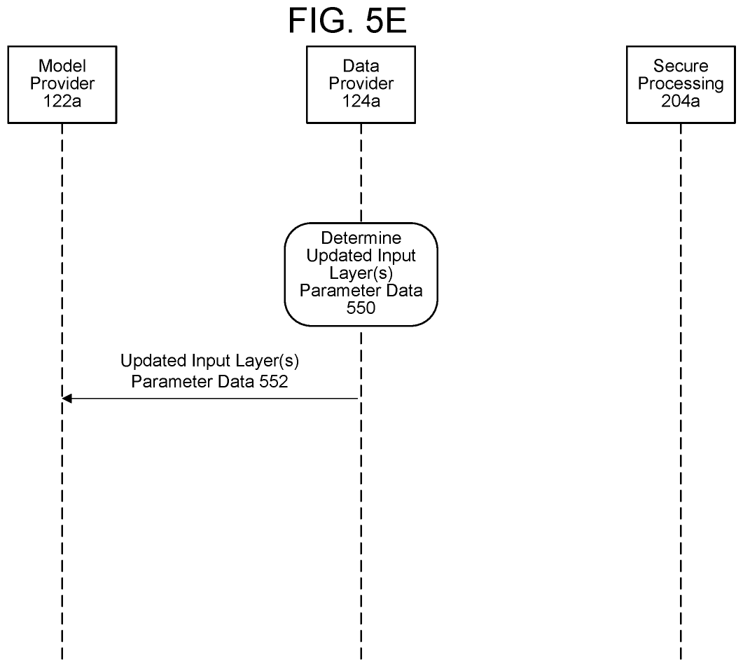

FIGS. 5A-5E illustrate processing and data transfers using a computing environment that includes a model-provider system 122a, a data-provider system 124a, and a secure-processing component 204a according to embodiments of the present disclosure. Referring first to FIG. 5A (and also with reference to FIG. 4A), the data-provider system 124a may send, to the model-provider system 122a, a request (502) to enable prediction of one or more events using one or more items of input data. This request may include an indication of the event. If, for example, the event corresponds to predicted failure of a component corresponding to the model-provider system 122a, the indication may include information identifying the component, such as a description of the component, a function of the component, and/or a serial and/or model number of the component. The indication may further include a desired time until failure of the component, such as one day, two days, one week, or other such duration of time.

In some embodiments, the model-provider system 122a may, upon receipt of the request, send a corresponding acknowledgement (504) indicating acceptance of the request. The acknowledgement may indicate that the model-provider system is capable of enabling prediction of occurrence of the event (within, in some embodiments, the desired duration of time). In some embodiments, however, the model-provider system 122a may send, to the data-provider system, response data. This response data may include a request for further information identifying the component (such as additional description of the component and/or further information identifying the component, such as a make and/or model number). The data-provider system 124a may then send, in response to the request, the additional information, and the model-provider system 122a may then send the acknowledgement in response.

The response data may further include an indication of a period of time corresponding to the prediction of the event different from the period of time requested by the data-provider system 124a. For example, the data-provider system 124a may request that the prediction corresponds to a period of time approximately equal to two weeks before failure of the component. The model-provider system 122a may be incapable of enabling this prediction; the model-provider system 122a may therefore send, to the data-provider system 124a, an indication of a prediction that corresponds to a period of time approximately equal to one week before failure of the component. The data-provider system 124a may accept or reject this indication and may send further data to the model-provider system 122a indicating the acceptance or rejection; the model-provider system 122a may send the acknowledgement in response. The model-provider system 122a may further send, to the data/model processing system 120a and/or the secure processing component 204a, a notification (506) indication the initiation of processing. Upon receipt, the data/model processing system 120a and/or secure processing component 204a may create or otherwise enable use of the secure processing component 204a, which may be referred to as a container, data silo, and/or sandbox. The secure processing component 204a may thus be associated with computing and/or software resources capable of performing processing using one or more layer(s) of a model, as described herein without making the details of said processing, such as parameters associated with the layer(s), known to at least one other system (such as the data-provider system 124a).

The model-provider system 122a may then select a model 128 corresponding to the request (502) and/or data-provider system 124a and determine parameters associated with the model 128. The parameters may include, for one or more nodes in the model, neural-network weights, neural-network offsets, or other such parameters. The parameters may include a set of floating-point or other numbers representing the weights and/or offsets.

The model-provider system 122a may select a model 128 previously trained (or partly trained) in response to a previous request similar to the request 502 and/or data from a previous data-provider system 124 similar to the data-provider system 124a. For example, if the data-provider system 124a is an energy-provider company, the model-provider system 122a may select a model 128 trained using data from other energy-provider companies. Similarly, if the request 502 is associated with a particular component, the model-provider system 122a may select a model 128 trained using data associated with the component. The model-provider system 122a may then determine (508) initial parameter data associated with the selected model 128. In other embodiments, the model-provider system 122a selects a generic model 128 and determines default and/or random parameters for the generic model 128.

The model-provider system 122a may then send, to the data provider system 124, input layer(s) initial parameter data (510) and output layer(s) initial parameter data (512). The model-provider system 122a may similarly send, to the secure-processing component 204a, transform layer(s) initial parameter data (514). This sending of the initial data 510, 512, 514 may be performed once for each data-provider system 124a and/or secure-processing component 204a (and then, as described below, multiple training steps may be performed using these same sets of initial data 510, 512, 514). In other embodiments, the model-provider system 122a may determine and send different sets of initial data 510, 512, 514 (and/or model layer(s)) for each training step and/or sets of training steps.

In some embodiments, if the data-provider system 124a and/or the secure-processing component 204a does not possess or otherwise have access to the input layer(s) 404, transformation layer(s 410), and/or output layer(s) 416, the model-provider system 122a may further send, to the data-provider system 124a, the input layer(s) 404 and/or output layer(s) 416 (and/or indication(s) thereof) and send, to the secure-processing component 204, the transformation layer(s) 410 (and/or an indication thereof).

Referring to FIG. 5B, the data-provider system 124 may process input data, such as the input data 402 of FIG. 4A, using the input layer(s) 404 and the input layer(s) initial parameter data 510 to determine initial feature data (520), which may be the feature data 408, and may send the initial feature data 522 to the secure-processing component 204a. In other words, the initial feature data (520) is the output of the first layer(s) 404 of the model given the input data 402 and the initial input layer(s) parameter data (510).

The secure-processing system 204a, upon receipt of the initial feature data (522), may similarly process (524) the initial feature data (522) using the transformation layer(s) 410 and the transformation layer(s) initial parameter data (514) to determine initial transformed data 526, which may similarly be the output of the transformation layer(s) 410. The secure-processing component 204a may similarly send the initial transformed data (526) to the data-provider system 124.

Referring to FIG. 5C, the data-provider system 124a now has the initial output layer(s) parameter data (512), the initial transformed data (526), as well as the actual target output data (e.g., the data in the data source 126). Using this data, the data-provider system 124a may determine updated output layer(s) parameter data (532) by training the output layer(s) 416. This training may be performed using an algorithm, such as a stochastic gradient descent (SGD) algorithm, by minimizing the value of a loss function that compares the initial output layer(s) parameter data (512) and the target data and determines updated output layer(s) parameter data (532) that minimizes the value of the loss function. The data-provider system 124a may then send the updated output layer(s) parameter data (532) to the model-provider system 122a.

The data-provider system 124a may further determine (534) updated transformed data (536), which it may send to the secure-processing component 204a. The data-provider system 124a may make this determination using the output layer(s) and the updated output layer(s) parameter data (530), as determined above, by holding the parameters constant and back-propagating output data through the output layer(s) 416. This back-propagation may be referred to as a coarse-grained back-propagation. In greater detail, the loss function may be used to compare the initial output layer(s) parameter data (512) and the target data, and the updated transformed data (536) may be determined in accordance with the partial derivative of the output of the loss function with respect to the transformed data (526). This operation is illustrated below in Equation (18). Determination of the updated output layer(s) parameter data (530) and of the updated transformed data (534) may be performed simultaneously (e.g., in the same SGD loop) or separately.

input_{updat}=inputᵢₙᵢₜ−η{∂L(output;target))/∂(input)} (18)

In the above Equation (18), η denotes a multiple factor that corresponds to the learning rate.

Referring to FIG. 5D, upon receipt of the updated transformed data (536), the secure-processing component 204a determines (540) updated transformation layer(s) parameter data (542). Similar to the above, the secure-processing component 204a may compare, using a loss function, the updated transformed data (536) and the initial transformed data (526) and minimize the loss function by performing an SGD algorithm using the transform layer(s).

The secure-processing component 204a further determines (544) updated feature data (546) and sends the updated feature data (546) to the data-provider system 124a. Similar to the above, the secure-processing component 204a may perform a coarse-grained back-propagation using the updated transformed data (536) and the initial transformed data (526) to determine the updated feature data (546). In greater detail, the loss function may be used to compare the updated transformed data (536) and the initial transformed data (526, and the updated feature data (546) may be determined in accordance with the partial derivative of the output of the loss function with respect to the feature data, as shown above in Equation (18).

Referring to FIG. 5E, the data-provider system 124a, upon receipt of the updated feature data (546), determines (550) updated input layer(s) parameter data (552), which it may send to the model-provider system 122a. Similar to the above, the data-provider system 124a may compare the initial feature data (522) with the updated feature data (546) using a loss function and determine updated input layer(s) parameter data (552) using an SGD operation.

The above discussion relates to embodiments of the present disclosure in which one or more of the input layer(s) 404, transform layer(s) 410, and/or output layer(s) 416 may be trained. During runtime operation (using, e.g., out-of-sample data), the data-provider system 124 may determine feature data 408 using out-of-sample input data 402 and may send the feature data 408 to the secure-processing component 204a. The secure-processing component 204a may process the feature data 408 using the transform layer(s) 410 to determine transformed data 414, which it may send back to the data-provider system 124a. The data-provider system 124a may then process, using the output layer(s) 416, the transformed data 414 to determine output data 420. The output data 420 may correspond to a prediction of an event corresponding to the input data 402.

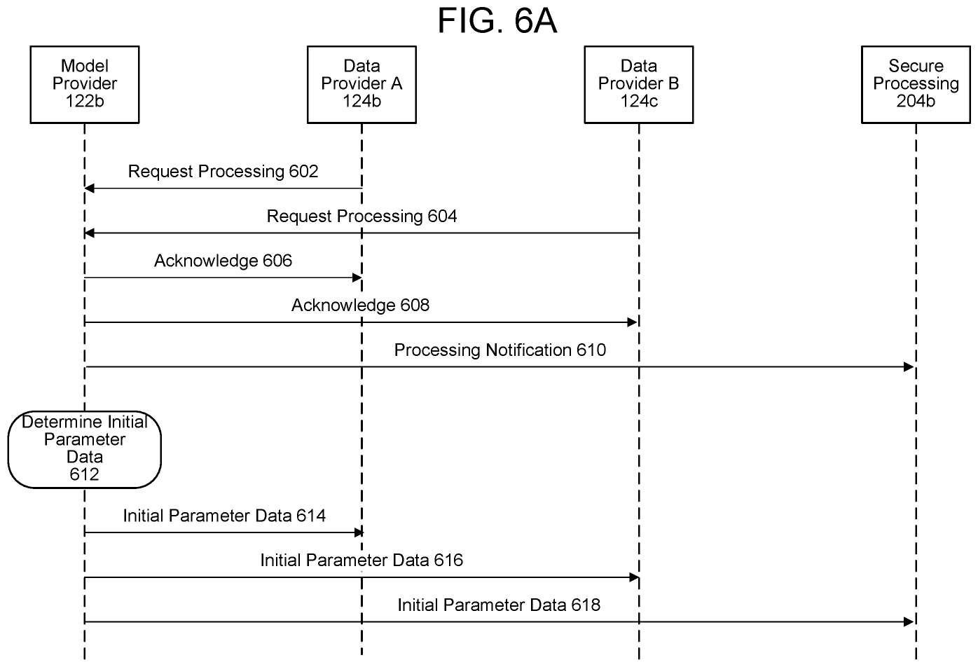

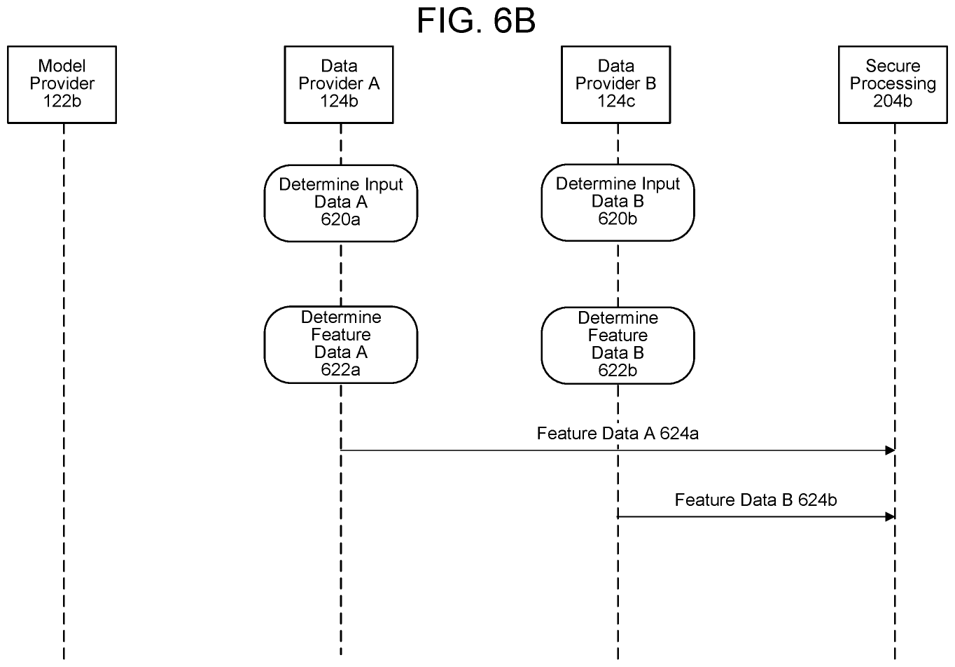

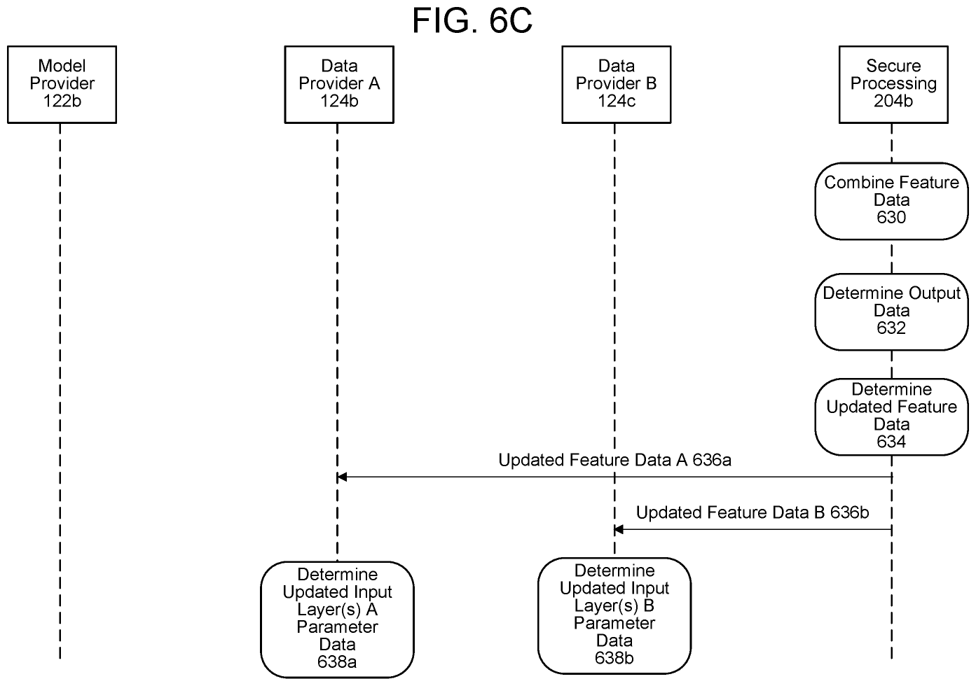

FIGS. 6A-6C illustrate processing and data transfers that may include vertically partitioned data using a computing environment that includes a model-provider system 122b, a first data-provider system A 124b, a second data-provider system B 124c, and a secure-processing component 204b according to embodiments of the present disclosure. As described above with respect to, for example, FIG. 4B, the first data-provider system A 124b may provide a first subset of data for a model 128, and the second data-provider system B 124c may provide a second subset of data for the model 128 (e.g., the data-provider system A 124b and the second data-provider system B 124c may provide vertically partitioned data).

Referring first to FIG. 6A (and also with reference to FIG. 4B), the first data-provider system A 124b may send, to the model-provider system 122b, a first request (602) to enable prediction of one or more events using one or more first items of vertically partitioned input data, and the second data-provider system B 124c may send, to the model-provider system 122b, a second request (604) to enable prediction of one or more events using one or more second items of vertically partitioned input data. As described above with reference to FIG. 5A, each request may include other data, such as a desired time of prediction, and the model-provider system 122b may send one or more further requests for more information. The model-provider system may send acknowledgement notifications 606, 608 to each of the data-provider systems 124a, 124b, and may send a processing notification (610) to the secure-processing component 204b.

The model-provider system 122b may then select a model 128 corresponding to the requests (602), (604) and/or data-provider systems 124b, 124c and determine parameters associated with the model 128. The parameters may include, for one or more nodes in the model, neural-network weights, neural-network offsets, or other such parameters. The parameters may include a set of floating-point or other numbers representing the weights and/or offsets.

The model-provider system 122b may select a model 128 previously trained (or partly trained) in response to a previous request similar to the requests 602, 604 and/or data from a previous data-provider system 124 similar to the data-provider systems 124b, 124c. The model-provider system 122b may then determine (612) initial parameter data associated with the selected model 128. In other embodiments, the model-provider system 122b selects a generic model 128 and determines default and/or random parameters for the generic model 128.

The model-provider system 122b may then send, to first data-provider system A 124b, first initial parameter data (614), to the second data-provider system 124c, second initial parameter data (616), and to the secure-processing component 204b, third initial parameter data (618). This sending of the initial data 614, 616, 618 may be performed once for each data-provider system 124b, 124c and/or secure-processing component 204b (and then, as described below, multiple training steps may be performed using these same sets of initial data 614, 616, 618). In other embodiments, the model-provider system 122b may determine and send different sets of initial data 614, 616, 618 (and/or model layer(s)) for each training step and/or sets of training steps.

Referring to FIG. 6B, the first data-provider system A 124b may determine first input data A (620a), and the second data-provider system 124c may determine second input data B (620b). The first and second input data 620a, 620b may be vertically partitioned data, such as the data 310, 312 illustrated in FIG. 3B. The first data-provider system A 124a may then process the first input data 620a using first input layer(s) 432a to determine first feature data A 622a, and the second data-provider system 124c may process the second input data 620a using second input layer(s) 434b to determine second feature data 622b. The first data-provider system A 124b may then send the first feature data A 624A to the secure-processing component 204b, and the second data-provider system B 124c may send the second feature data 624B to the secure-processing component 204b.

Referring to FIG. 6C, the secure-processing component 204b may combine (630) (e.g., via concatenation) the first feature data A 624A and the second feature data B 624b to determine combined feature data. The secure-processing component 204b may then process the combined feature data using, for example, output layer(s) 438 in accordance with output layer(s) parameter data 440, to determine (632) output data 442. Using the output data 442 and target output data, in accordance with Equation (19), the secure-processing element may determine (634) updated feature data 436. The secure-processing component 204a may send (636a), to the first data-provider system A 124b, a first portion of the updated feature data 436; this first portion may correspond to the portion of the input data A 620a determined by the first data-provider system 124b. The secure-processing component 204a may send (636b), to the second data-provider system B 124c, a second portion of the updated feature data 436; this second portion may correspond to the portion of the input data A 620b determined by the second data-provider system 124c.

The first data-provider system A 124a may then determine (638a) updated input layer(s) parameter data by comparing the updated feature data A with target feature data, and the second data-provider system B may determine (638b) updated input layer(s) parameter data by comparing the updated feature data B with target feature data. The first and/or second data-provider systems 124 may then use the updated parameter data to process further (e.g., out-of-sample) input data to determine a prediction of an event corresponding to the input data.

In various embodiments, the secure-processing component 204b, selects a subset (e.g., a sample) of the output layer(s) parameter data 440 to determine the updated feature data. The subset may be, for example, a single latest-determined set of values of the updated feature data. The subset may instead or in addition correspond to a weighted average of a set of latest-determined values of the updated feature data, in which later-determined values have a higher weight than earlier-determined values. In other embodiments, the secure-processing component 204a determines a distribution (such as a marginal distribution and/or Gaussian distribution) that represents values of the parameter data 440 and samples the distribution to determine the subset.

In some embodiments, each data-provider system 124 may further determine updated parameter values for its corresponding output layer(s). This determination may be referred to as fine-tuning the output layer(s) (e.g., modifying the parameters of the output layer(s) in accordance with target data corresponding to a particular data-provider system 124. A data-provider system 124 may thus use the updated parameters of the output layer(s) 440, as well as the updated parameters of the input layer(s) 432, as described above) to process input data 430 to determine output data 442 corresponding to prediction of an event.

As mentioned above, a neural network may be trained to perform some or all of the computational tasks described herein. The neural network, which may include input layer(s) 404, 432 transform layer(s) 410, and/or output layer(s) 416, 438 may include nodes within the input layer(s) 404, 432 transform layer(s) 410, and/or output layer(s) 416 that are further organized as an input layer, one or more hidden layers, and an output layer. The input layer of each of the input layer(s) 404, 432 transform layer(s) 410, and/or output layer(s) 416 may include m nodes, the hidden layer(s) may include n nodes, and the output layer may include o nodes, where m, n, and o may be any numbers and may represent the same or different numbers of nodes for each layer. Each node of each layer may include computer-executable instructions and/or data usable for receiving one or more input values and for computing an output value. Each node may further include memory for storing the input, output, or intermediate values. One or more data structures, such as a long short-term memory (LSTM) cell or other cells or layers may additionally be associated with each node for purposes of storing different values. Nodes of the input layer may receive input data, and nodes of the output layer may produce output data. In some embodiments, the input data corresponds to data from a data source, and the outputs correspond to model output data. Each node of the hidden layer may be connected to one or more nodes in the input layer and one or more nodes in the output layer. Although the neural network may include a single hidden layer, other neural networks may include multiple middle layers; in these cases, each node in a hidden layer may connect to some or all nodes in neighboring hidden (or input/output) layers. Each connection from one node to another node in a neighboring layer may be associated with a weight or score. A neural network may output one or more outputs, a weighted set of possible outputs, or any combination thereof.

In some embodiments, a neural network is constructed using recurrent connections such that one or more outputs of the hidden layer of the network feeds back into the hidden layer again as a next set of inputs. Each node of the input layer connects to each node of the hidden layer(s); each node of the hidden layer(s) connects to each node of the output layer. In addition, one or more outputs of the hidden layer(s) is fed back into the hidden layer for processing of the next set of inputs. A neural network incorporating recurrent connections may be referred to as a recurrent neural network (RNN). An RNN or other such feedback network may allow a network to retain a “memory” of previous states and information that the network has processed.

Processing by a neural network may be determined by the learned weights on each node input and the structure of the network. Given a particular input, the neural network determines the output one layer at a time until the output layer of the entire network is calculated. Connection weights may be initially learned by the neural network during training, where given inputs are associated with known outputs. In a set of training data, a variety of training examples are fed into the network. As examples in the training data are processed by the neural network, an input may be sent to the network and compared with the associated output to determine how the network performance compares to the target performance. Using a training technique, such as backpropagation, the weights of the neural network may be updated to reduce errors made by the neural network when processing the training data.

The model(s) discussed herein may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by decision boundaries. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component such as, in this case, one of the first or second models, may require establishing a “ground truth” for the training examples. In machine learning, the term “ground truth” refers to an expert-defined label for a training example. Machine learning algorithms may use datasets that include “ground truth” information to train a model and to assess the accuracy of the model. Various techniques may be used to train the models including backpropagation, statistical learning, supervised learning, semi-supervised learning, stochastic learning, stochastic gradient descent, or other known techniques. Thus, many different training examples may be used to train the classifier(s)/model(s) discussed herein. Further, as training data is added to, or otherwise changed, new classifiers/models may be trained to update the classifiers/models as desired. The model may be updated by, for example, back-propagating the error data from output nodes back to hidden and input nodes; the method of back-propagation may include gradient descent.

In some embodiments, the trained model is a deep neural network (DNN) that is trained using distributed batch stochastic gradient descent; batches of training data may be distributed to computation nodes where they are fed through the DNN in order to compute a gradient for that batch. The secure processor 204 may update the DNN by computing a gradient by comparing results predicted using the DNN to training data and back-propagating error data based thereon. In some embodiments, the DNN includes additional forward pass targets that estimate synthetic gradient values and the secure processor 204 updates the DNN by selecting one or more synthetic gradient values.

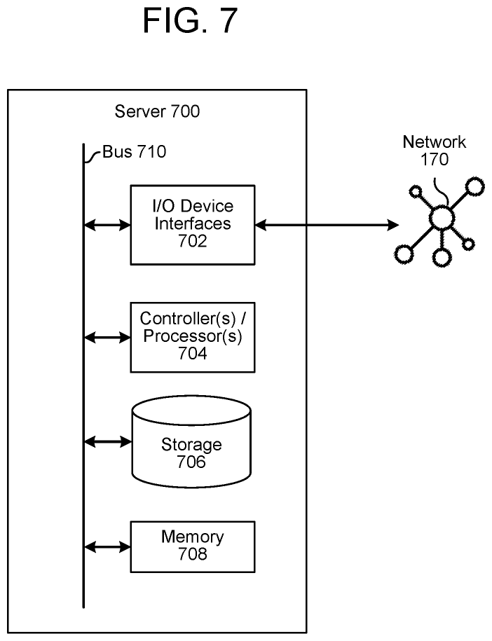

FIG. 7 is a block diagram illustrating a computing environment that includes a server 700; the server 700 may be the data/model processing system 120a/120b, model-provider system 122a/122b, and/or data-provider system 124a/124b. The server 700 may include one or more input/output device interfaces 702 and controllers/processors 704. The server 700 may further include storage 706 and a memory 708. A bus 710 may allow the input/output device interfaces 702, controllers/processors 704, storage 706, and memory 708 to communicate with each other; the components may instead or in addition be directly connected to each other or be connected via a different bus.

A variety of components may be connected through the input/output device interfaces 702. For example, the input/output device interfaces 702 may be used to connect to the network 170. Further components include keyboards, mice, displays, touchscreens, microphones, speakers, and any other type of user input/output device. The components may further include USB drives, removable hard drives, or any other type of removable storage.

The controllers/processors 704 may processes data and computer-readable instructions and may include a general-purpose central-processing unit, a specific-purpose processor such as a graphics processor, a digital-signal processor, an application-specific integrated circuit, a microcontroller, or any other type of controller or processor. The memory 708 may include volatile random access memory (RAM), non-volatile read only memory (ROM), non-volatile magnetoresistive (MRAM), and/or other types of memory. The storage 706 may be used for storing data and controller/processor-executable instructions on one or more non-volatile storage types, such as magnetic storage, optical storage, solid-state storage, etc.

Computer instructions for operating the server 700 and its various components may be executed by the controller(s)/processor(s) 704 using the memory 708 as temporary “working” storage at runtime. The computer instructions may be stored in a non-transitory manner in the memory 708, storage 706, and/or an external device(s). Alternatively, some or all of the executable instructions may be embedded in hardware or firmware on the respective device in addition to or instead of software.

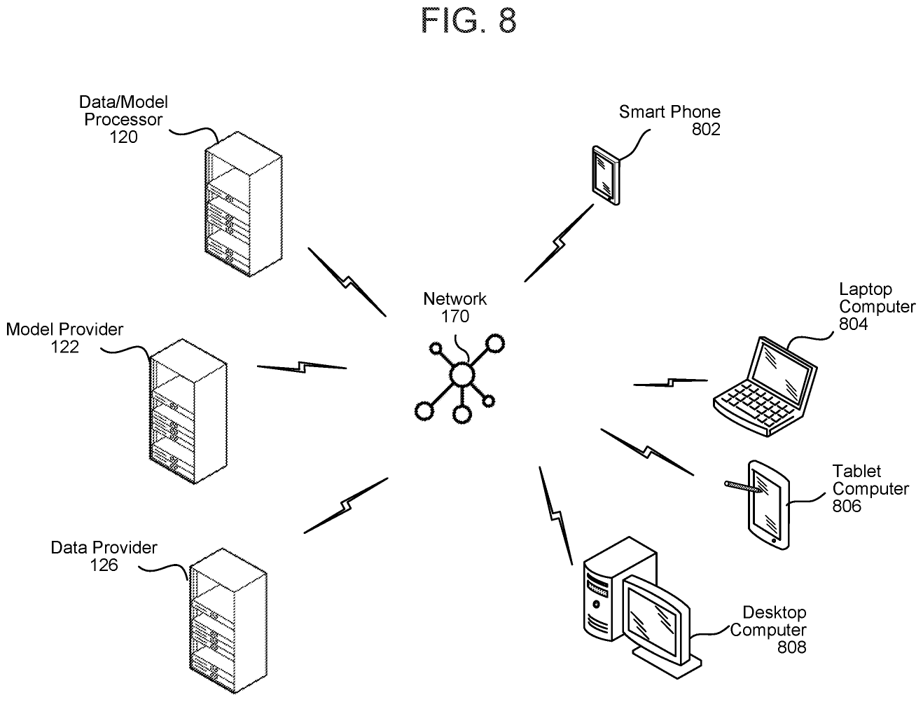

FIG. 8 illustrates a number of devices in communication with the data/model processing system 120a/120b, model-provider system 122a/122b, and/or data-provider system 124a/124b using the network 170a/170b. The devices may include a smart phone 802, a laptop computer 804, a tablet computer 806, and/or a desktop computer 808. These devices may be used to remotely access the data/model processing system 120a/120b, model-provider system 122a/122b, and/or data-provider system 124a/124b to perform any of the operations described herein.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and data processing should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of one or more of the modules and engines may be implemented as in firmware or hardware, which comprises, among other things, analog and/or digital filters (e.g., filters configured as firmware to a digital signal processor (DSP)).

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. As used in this disclosure, the term “a” or “one” may include one or more items unless specifically stated otherwise. Further, the phrase “based on” is intended to mean “based at least in part on” unless specifically stated otherwise.

In various embodiments, a computer-implemented method comprises processing, by a first system using an input layer of a neural-network model, first input data to determine first feature data, the input layer corresponding to first neural-network parameters; sending, from the first system to a second system, the first feature data;

receiving, at the first system from the second system, first transformed data corresponding to the first feature data and determined by a transformation layer of the neural-network model; processing, by the first system, the first transformed data using an output layer of the neural-network model to determine first output data;

determining, by the first system, second transformed data corresponding to the first output data and target output data; sending, from the first system to the second system, the second transformed data; receiving, at the first system from the second system, second feature data corresponding to the second transformed data and target transformed data; determining, by the first system, second neural-network parameters corresponding to the second feature data and target feature data; and processing, by the first system using the input layer and the second neural-network parameters, second input data corresponding to an event to determine third feature data corresponding to a prediction of the event.

Determining the second transformed data may comprise determining, using a loss function, a difference between the first output data and the target output data; and determining a partial derivative of the difference with respect to the second transformed data.

Determining the second feature data may comprises determining, using a loss function, a difference between the second transformed data and the target transformed data; and determining a partial derivative of the difference with respect to the second feature data.

The method may further comprise sending, to a third system, the second neural-network parameters; sending from the third system to a fourth system, data based at least in part on the second neural-network parameters; and processing, by the fourth system using the data, third input data to determine fourth feature data.

The method may further comprise sending, to the second system, the third feature data; receiving, at the first system from the second system, third transformed data corresponding to the third feature data; and processing, by the first system using the output layer of the neural-network model and the third transformed data, the third transformed data to determine output data representing the prediction.

The computer-implemented method of claim 1, wherein the event corresponds to failure of a component corresponding to the first system and wherein the first input data corresponds to operational data corresponding to the component.

The event may correspond to a change in a network corresponding to the first system and wherein the first input data corresponds to operational data corresponding to the network.

The method may further comprise processing, by the second system, the first feature data using a transformation layer of the neural-network mode to determine the first transformed data; and determining, by the second system, the second feature data corresponding to the first output transformed data and target output transformed data.

Processing the first feature data may be based at least in part on an affine transformation.

The method may further comprise determining, by a third system, third neural-network parameters corresponding to the transformation layer, the third neural-network parameters based at least in part on a random value; and sending, from the third system to the second system, the third neural-network parameters.

In various embodiments, a computer-implemented method may comprise receiving, from a first data-provider system at a second system, first feature data determined by a first input layer of a first neural-network model, the first feature data corresponding to a first subset of inputs to an output layer of the first neural-network model; receiving, from a second data-provider system at the second system, second feature data determined by a second input layer of a second neural-network model, the second feature data corresponding to a second subset of inputs to the output layer; determining, by the second system, first combined feature data corresponding to the first feature data and the second feature data; processing, by the second system using the an output layer corresponding to the first of the neural-network model and the second neural-network model, the first combined feature data to determine output data; determining, by the second system, second combined feature data corresponding to the first combined feature data and target feature data; sending, from the second system to the first data-provider system, third feature data corresponding to the second combined feature data and the first subset; and processing, by the first data-provider system using the first neural-network model and based at least in part on the third feature data, input data corresponding to an event to determine fourth feature data representing a prediction of the event.

The event may correspond to a change in a first network corresponding to the first data-provider system, wherein the first feature data corresponds to first operational data corresponding to the first network, and wherein the second feature data corresponds to second operational data corresponding to a second network different from the first network.

Determining the second transformed combined feature data may comprise processing the second combined feature data using an output layer of a third neural-network to determine second output data; determining, using a loss function, a difference between the second output data and the target output data; determining a partial derivative of the difference with respect to the second combined feature data; and determining the third feature data based at least in part on the partial derivative.

The method may further comprise determining parameter data corresponding to an output layer of a third fourth neural-network; and determining a sample of the parameter data, wherein the output data corresponds to the sample.

Determining the sample may comprise at least one of: determining a weighted average corresponding to the parameter data; or determining a distribution representing the parameter data.

The method may further comprise receiving, from a third data-provider system at the second system, fifth feature data determined by a third input layer of a third neural-network model, the first feature data corresponding to the first subset of inputs and to the second subset of inputs; and processing, by the second system using the output layer corresponding to the first neural-network model and the second neural-network model, the fifth feature data to determine second output data.

The method may further comprise processing, by the first data-provider system, the fourth feature data by an output layer of the first neural-network model to determine output data representing the prediction of the event.

The method may further comprise sending, from the second system to the second data-provider system, fifth feature data corresponding to the second combined feature data and the second subset; and processing, by the second data-provider system using the second neural-network model and based at least in part on the fifth feature data, second input data corresponding to a second event to determine sixth feature data representing a prediction of the second event.

The method may further comprise processing, by the first data-provider system, fifth feature data by an output layer of the first neural-network model to determine output data; determining a difference, using a loss function, between the output data and target output data; and determining, by the first data-provider system, neural-network parameters corresponding to the output layer based at least in part on the difference.

The method may further comprise sending, from the first data-provider system to the second data-provider system, encryption data; receiving, from the second data-provider system at the first data-provider system, encrypted data corresponding to the encryption data; and decrypting the encrypted data in accordance with the encryption data to determine second data.

What is claimed is:

1. A computer-implemented method comprising:
processing, by a first system using an input layer of a neural-network model, first input data to determine first feature data, the input layer corresponding to first neural-network parameters;
sending, from the first system to a second system, the first feature data;
receiving, at the first system from the second system, first transformed data corresponding to the first feature data and determined by a transformation layer of the neural-network model;
processing, by the first system, the first transformed data using an output layer of the neural-network model to determine first output data;
determining, by the first system, second transformed data corresponding to the first output data and target output data;
sending, from the first system to the second system, the second transformed data;
receiving, at the first system from the second system, second feature data corresponding to the second transformed data and target transformed data;
determining, by the first system, second neural-network parameters corresponding to the second feature data and target feature data; and
processing, by the first system using the input layer and the second neural-network parameters, second input data corresponding to an event to determine third feature data corresponding to a prediction of the event.

2. The computer-implemented method of claim 1, wherein determining the second transformed data comprises:
determining, using a loss function, a difference between the first output data and the target output data; and
determining a partial derivative of the difference with respect to the second transformed data.

3. The computer-implemented method of claim 1, wherein determining the second feature data comprises:
determining, using a loss function, a difference between the second transformed data and the target transformed data; and
determining a partial derivative of the difference with respect to the second feature data.

4. The computer-implemented method of claim 1, further comprising:
sending, to a third system, the second neural-network parameters;
sending from the third system to a fourth system, data based at least in part on the second neural-network parameters; and
processing, by the fourth system using the data, third input data to determine fourth feature data.

5. The computer-implemented method of claim 1, further comprising:
sending, to the second system, the third feature data;
receiving, at the first system from the second system, third transformed data corresponding to the third feature data; and
processing, by the first system using the output layer of the neural-network model and the third transformed data, the third transformed data to determine output data representing the prediction.

6. The computer-implemented method of claim 1, wherein the event corresponds to failure of a component corresponding to the first system and wherein the first input data corresponds to operational data corresponding to the component.

7. The computer-implemented method of claim 1, wherein the event corresponds to a change in a network corresponding to the first system and wherein the first input data corresponds to operational data corresponding to the network.

8. The computer-implemented method of claim 1, further comprising:
processing, by the second system, the first feature data using a transformation layer of the neural-network model to determine the first transformed data; and
determining, by the second system, the second feature data corresponding to the first transformed data and target transformed data.

9. The computer-implemented method of claim 8, wherein processing the first feature data is based at least in part on an affine transformation.

10. The computer-implemented method of claim 1, further comprising:
determining, by a third system, third neural-network parameters corresponding to the transformation layer, the third neural-network parameters based at least in part on a random value; and
sending, from the third system to the second system, the third neural-network parameters.

11. A system comprising:
at least one processor; and
at least one memory including instructions that, when executed by the at least one processor, cause the system to:
process, by a first system using an input layer of a neural-network model, first input data to determine first feature data, the input layer corresponding to first neural-network parameters;
send, from the first system to a second system, the first feature data;
receive, at the first system from the second system, first transformed data corresponding to the first feature data and determined by a transformation layer of the neural-network model;
process, by the first system, the first transformed data using an output layer of the neural-network model to determine first output data;
determine, by the first system, second transformed data corresponding to the first output data and target output data;
sending, from the first system to the second system, the second transformed data;
receive, at the first system from the second system, second feature data corresponding to the second transformed data and target transformed data;
determine, by the first system, second neural-network parameters corresponding to the second feature data and target feature data; and
process, by the first system using the input layer and the second neural-network parameters, second input data corresponding to an event to determine third feature data corresponding to a prediction of the event.

12. The system of claim 11, wherein the at least one memory further comprises instructions that, when executed by the at least one processor, further cause the system to:
determine, using a loss function, a difference between the first output data and the target output data; and
determine a partial derivative of the difference with respect to the second transformed data.

13. The system of claim 11, wherein the at least one memory further comprises instructions that, when executed by the at least one processor, further cause the system to:
determine, using a loss function, a difference between the second transformed data and the target transformed data; and
determine a partial derivative of the difference with respect to the second feature data.

14. The system of claim 11, wherein the at least one memory further comprises instructions that, when executed by the at least one processor, further cause the system to:
send, to a third system, the second neural-network parameters;
send from the third system to a fourth system, data based at least in part on the second neural-network parameters; and
process, by the fourth system using the data, third input data to determine fourth feature data.

15. The system of claim 11, wherein the at least one memory further comprises instructions that, when executed by the at least one processor, further cause the system to:
send, to the second system, the third feature data;
receive, at the first system from the second system, third transformed data corresponding to the third feature data; and
process, by the first system using the output layer of the neural-network model and the third transformed data, the third transformed data to determine output data representing the prediction.

16. The system of claim 11, wherein the event corresponds to failure of a component corresponding to the first system and wherein the first input data corresponds to operational data corresponding to the component.

17. The system of claim 11, wherein the event corresponds to a change in a network corresponding to the first system and wherein the first input data corresponds to operational data corresponding to the network.

18. The system of claim 11, wherein the at least one memory further comprises instructions that, when executed by the at least one processor, further cause the system to:
process, by the second system, the first feature data using a transformation layer of the neural-network model to determine the first transformed data; and
determine, by the second system, the second feature data corresponding to the first transformed data and target transformed data.

19. The system of claim 11, wherein processing the first feature data is based at least in part on an affine transformation.

20. The system of claim 11, wherein the at least one memory further comprises instructions that, when executed by the at least one processor, further cause the system to:
determine, by a third system, third neural-network parameters corresponding to the transformation layer, the third neural-network parameters based at least in part on a random value; and
send, from the third system to the second system, the third neural-network parameters.
